(19) United States
(12) Patent Application Publication
(10) Pub. No.: US 2010/0080489 A1
(43) Pub. Date: Apr. 1, 2010

(54) Hybrid Interface for Interactively Registering Images to Digital Models

(75) Inventors: Billy Chen, Bellevue, WA (US); Eyal Ofek, Redmond, WA (US); Gonzalo Ramos, Bellevue, WA (US); Michael F. Cohen, Seattle, WA (US); Steven M. Drucker, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/242,745

(22) Filed: Sep. 30, 2008

(51) Int. Cl. G06K 9/36

(52) U.S. Cl. 382/285

(57) ABSTRACT

The first image may be displayed adjacent to the second image where the second image is a three dimensional image. An element may be selected in the first image and a matching element may be selected in the second image. A selection may be permitted to view a merged view where the merged view is the first image displayed over the second image by varying the opaqueness of the images. If the merged view is not acceptable, the method may repeat and if the merged view is acceptable; the first view onto the second view and the merged view may be stored as a merged image.

### BACKGROUND

This Background is intended to provide the basic context of this patent application and it is not intended to describe a specific problem to be solved.

With the advent of publically available 3D building models and digital terrain, users are now beginning to not only geotag their photos but also to align them to these digital models. Fusing a photograph to 3D models enables a variety of novel applications including photograph enhancement, 3D slideshows, and scalable photo browsing. Unfortunately, current techniques for aligning a photograph to its 3D counterpart are difficult and lack good user feedback. Photographs can look very different, as compared to their 3D models, due to differences in viewpoint, lighting, geometry or appearance. This application discloses techniques for aligning 2D images to 3D models.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method and system of combining a first image and a second image is disclosed. The first image may be displayed adjacent to the second image where the second image is a three dimensional image. An element may be selected in the first image and a matching element may be selected in the second image. A selection may be permitted to view a merged view where the merged view is the first image (or some subset or derivative of the first image) displayed over (or combined in a general way to) the second image (or some subset or derivative of the second image) by varying the opaqueness (or other properties) of the images. If the merged view is not acceptable, the method may repeat and if the merged view is acceptable; the first view onto the second view and the merged view may be stored as a merged image.

### BRIEF DESCRIPTION OF THE DRAWINGS

FIG. 1 is an illustration of a portable computing device;

FIG. 2 is an illustration of a method of combining a first image and a second image is disclosed; and

FIG. 3 is an illustration of two separate images being merged into a merged image.

### SPECIFICATION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

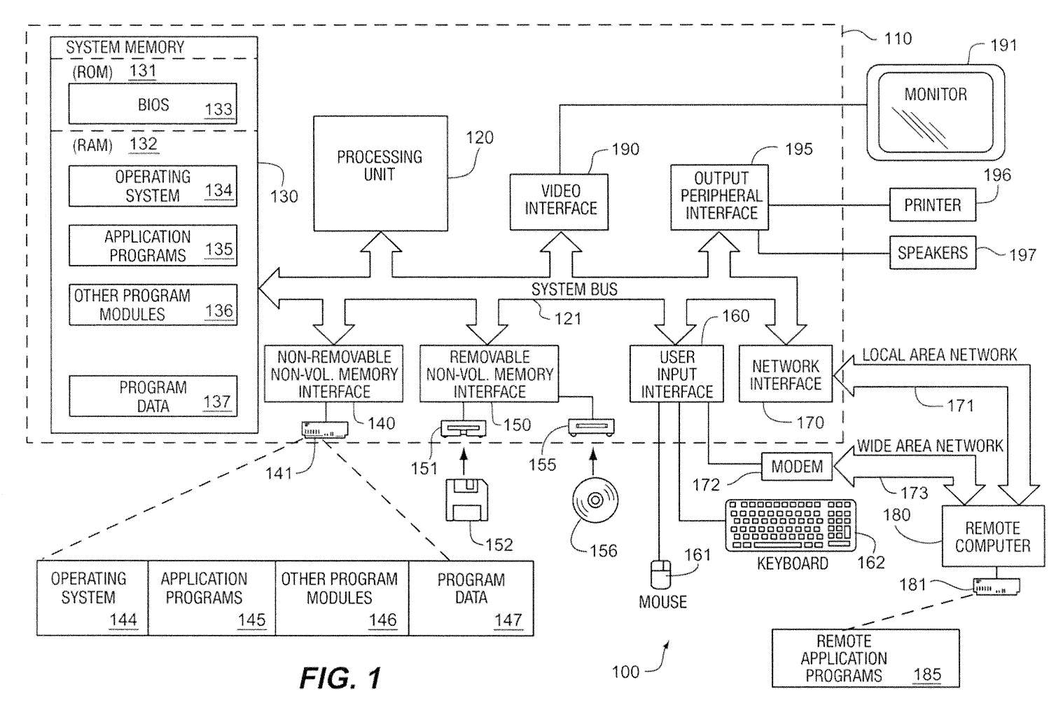

FIG. 1 illustrates an example of a suitable computing system environment 100 that may operate to display and provide the user interface described by this specification. It should be noted that the computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100.

With reference to FIG. 1, an exemplary system for implementing the blocks of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120.

The computer 110 may operate in a networked environment using logical connections to one or more remote computers, such as a remote computer 180, via a local area network (LAN) 171 and/or a wide area network (WAN) 173 via a modem 172 or other network interface 170.

Computer 110 typically includes a variety of computer readable media that may be any available media that may be accessed by computer 110 and includes both volatile and nonvolatile media, removable and non-removable media. The system memory 130 includes computer storage media in the form of volatile and/or nonvolatile memory such as read only memory (ROM) 131 and random access memory (RAM) 132. The ROM may include a basic input/output system 133 (BIOS). RAM 132 typically contains data and/or program modules that include operating system 134, application programs 135, other program modules 136, and program data 137. The computer 110 may also include other removable/non-removable, volatile/nonvolatile computer storage media such as a hard disk drive 141 a magnetic disk drive 151 that reads from or writes to a magnetic disk 152, and an optical disk drive 155 that reads from or writes to an optical disk 156. The hard disk drive 141, 151, and 155 may interface with system bus 121 via interfaces 140, 150.

A user may enter commands and information into the computer 20 through input devices such as a keyboard 162 and pointing device 161, commonly referred to as a mouse, trackball or touch pad. Other input devices (not illustrated) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device may also be connected to the system bus 121 via an interface, such as a video interface 190. In addition to the monitor, computers may also include other peripheral output devices such as speakers 197 and printer 196, which may be connected through an output peripheral interface 190.

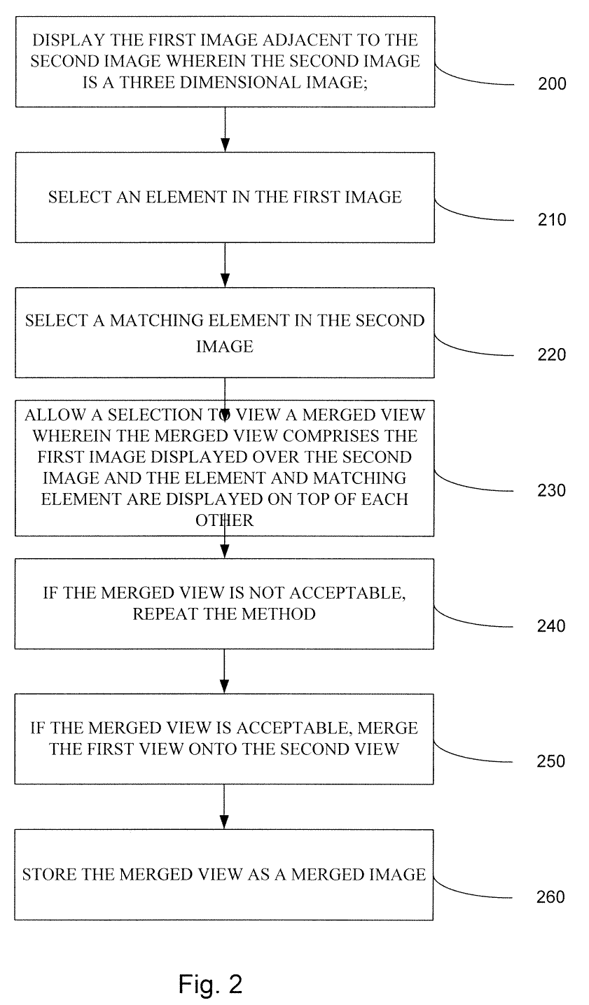

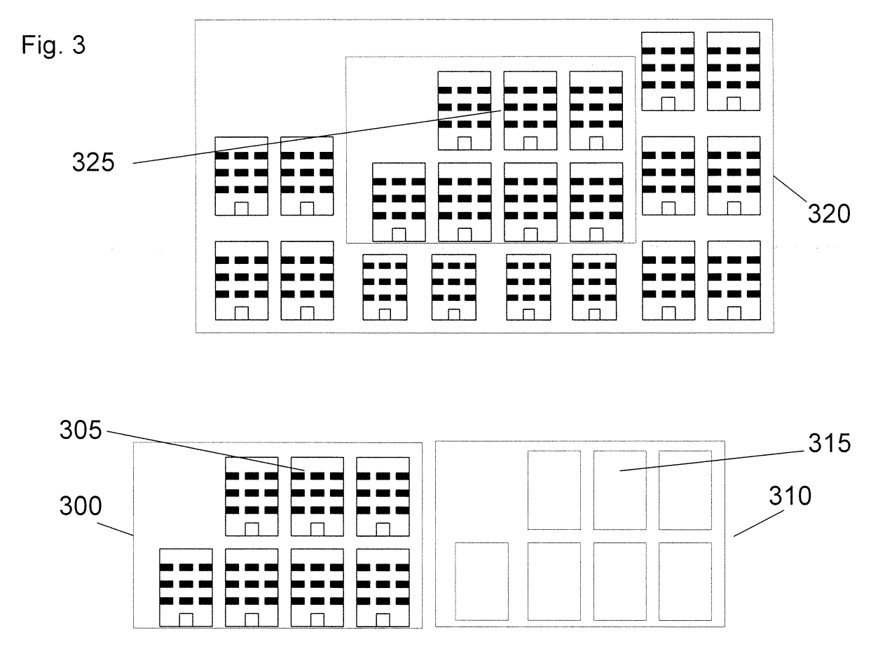

FIG. 2 may illustrate a method of combining a first image 300 (FIG. 3) and a second image 310 that may use the computing system 100 described in reference to FIG. 1. At block 200, the first image may be displayed adjacent to the second image. In some embodiments, the second image 310 is a three dimensional image where the elements of the image are displayed in three dimensions. In one embodiment, the images 300 310 are adjacent to each other but other arrangements are possible and are contemplated.

At block 210, an element 305 may be selected in the first image 300. The element may be any element such as a road, regions, sub-regions, visible object, visible faces; streets, rivers, bodies of water, etc. Of course, other elements are possible and are contemplated. In some embodiments, the element 305 in the first image that is selected is an element that is easy to see in both the first image 300 and the second image 310.

At block 220, a matching element 315 may be selected in the second image 310. For example and not limitation, in FIG. 4, a spire of a building is selected as an element 305 in the first image 300 and the spire is selected as the element 315 in the second image 310. The selection may be accomplished in a variety of manners such as pinning the spire 305 from the first image 300 on the spire 315 of the second image 310. In another embodiment, the application may make a logical guess as to the matching element 315 and may highlight the guessed logical matching element or lead the spire 305 from the first image 300 to be pinned on the spire 315 in the second image 310. Some feature matches may be located automatically, either before the user starts entering more matches, during the selection process or after the selection process.

At block 230, a selection may be made to view a merged view 320 wherein the merged view 320 may contain the first image 300 combined with the second image 310 and the element 305 and matching element 315 may be displayed on top of each other. In one embodiment, the merged view 320 may be a distinct display from the separate views of the first image 300 and the second image 310. In another embodiment, the merged view 320 is displayed on the same display as the separate views of the first image 300 and the second image 310.

To make the selection and merger easier, the method may rotate the geometry of the elements toward the image. However, the image may be projected on top of the geometry of the element, and a user may drag features of the image to the right position on the geometry.

In yet another embodiment, the display toggles between the separate view of the first image 300 and the second image 310 and the merged view 320. The toggling may occur in a variety of ways. In one embodiment, a user controls the toggling. In another embodiment, the application controls the toggling. In another embodiment, the application creates periodic toggling which may be overridden by a user. Of course, other methods of toggling are possible and are contemplated.

In another approach, the transparency of the second image to be varied. For example, as the element 305 from the first image 300 is dragged toward the same element 315 in the second image 310, the second image 310 may become opaque such that the first image 300 and second image 310 may both be seen in the merged display 320. The level of opaqueness may be controlled by a user or may be controlled automatically by the application.

In another embodiment, the elements 305 315 may be highlighted in a manner to make merging the images 300 310 easier. For example, elements 305 315 may be displayed as wireframes of buildings where wireframes comprise outlines of the buildings. In this way, the wireframes may be matched between the first image 300 and the second image 310. In a similar embodiment, the edges of objects 305 315 in the first 300 and second image 310 are highlighted. In this embodiment, it may be easier to match up or register the edges of the objects 305 315.

In another embodiment, one or both of the images 300 310 may be displayed at a low resolution. The images 300 310 may then be aligned in a general manner and then higher resolution may be used to obtain more precise alignment of the images 300 310. The higher resolution may offer additional ability to accurately match up the elements 305 315 in the images 300 310. In other words, low resolution may be used to make a rough approximation of how the elements 305 315 should be overlaid and merged and high resolution may be used to create a more detailed merged view 320.

The application may also help by coloring the areas with a high degree of mismatch a first color and coloring areas with a high degree of match a second color. For example, areas that appear to have matching elements 305 315 may be colored the same. Similarly, elements that do not appear to go together may be colored a different color.

The application may assist with matching the element 305 from the first image 300 with the element 315 from the second image 310. In one embodiment, after having lined up a portion of the first image 300 with the second image 310, a user or application may select to have the application complete a merger of the first and second image. The user or application may then have the option to accept the merged image 320 or adjust the merged image 320 or completely reject it, select some new matching elements 305 315 and start over. Setting more elements 305 315 may produce better matching images 320 and may make it easier for the application to complete the merged image 320.

When the user merges the split interface 300 310 to an overlay interface 320 (i.e. the “switch to overlay” process box), the user also may decide on what areas/objects/elements 305 315 in both views should be merged. For example, in the 3D view of the second image 310, the user may select:

the entire view—specific color channels, (e.g. red, green, blue, depth)

nearby pixels (in screen space)

nearby 3D region (in object space)

graphical semantic objects, like nearby points, edges, polygons, faces, and polyhedrons

nearby semantic objects, like a building, or a road, or a mountain

nearby visible objects—any type of filtering (3D or 2D) on the imagery, for example a perceptual filter like a Laplacian.

any number of information visualization algorithms, for example, false coloring the 3D view to show areas of high error in the registration

level of detail (i.e., a higher or lower resolution version of the 3D view)

a combination of any of the above

Correspondingly, in the 2-d image 300, the user may select any combination of “sub images,” including applicable techniques mentioned above and below:

the entire image—color channels

sub image around points of interest

non-linear fall-off functions near points of interest, including edge-preserving fall-offs, etc.

any type of 2D filtering (3D or 2D) on the imagery, for example a gradient operator

Once the user has selected two sub regions to merge, the user may also specify how these sub regions should be merged from the 3D view 310 and the image 300, to form the overlay display or interface 320. These include merging in:

color channel, for example, showing the 3D view in red, the image in green

time, by showing each view one after another

space, where these sub-regions to be placed, relative to each other

specifying a merging function, like averaging, or maximum, etc.

Once merged into an overlay interface 320, the user may continue to register points 305 315, as described above. The same process of selecting sub regions and specifying how to merge them may be applied when the user decides to separate the overlay interface 320 into the split one 300 310. By creating additional matching points 305 315, a more precise merged illustration 320 may be possible.

Algorithms may be used to assist in creating the merged image 320. The algorithm may be selected from a group of algorithms such as:
an algorithm that averages the first image and the second image,
an algorithm the creates the merged image to have a maximum of matching pixels between the first image and the second image and
an algorithm that creates the merged image to have a minimum of non-matching pixels between the first image and the second image.

When the quality of the fit is above some level, the system can automatically move from split mode to merged one. For example, if there are enough element matches of a high enough quality, the system may automatically display the merged view 320. Of course, other algorithms are possible and are contemplated.

At block 240, if the merged view 320 is not acceptable, the method may be repeated. For example, if the merged view 320 does not match up all the elements 305 315, the overlay image 320 may not look acceptable. To assist in this determination, in one embodiment, the second image 310 is opaque and the first image 300 may be seen through the second image 310 as the images are dragged together to form the merged image 320. Of course, either image 300 310 could be opaque. As stated previously, the level of opaqueness may be controlled by a user or may be controlled by the application. In another embodiment, the first image is first color and the second image is a second color and the images blend into a third color if they are placed over each other. For example, the first image 300 may be blue and the second image 310 may be yellow and when the two images 300 310 are aligned properly, the combined image 320 may be green.

At block 250, if the merged view is acceptable; the first view 300 may be merged onto the second view 310. At block 260, the merged view 320 may be stored as a merged image 320.

As an example in FIG. 3, a user may start with a split view 300 310, showing a photo of downtown Manhattan and an approximate 3D view. The user may see a particular building or object 305 he would like to correspond, and decides to enter into the overlay interface 320 to register (or match) it to the photo.

First, in the 3D view of the second image 310, the building 315 may be selected along with any adjacent roads. Then, the user specifies that the maximum level of detail for the building 315 is desired, with low-resolution detail for the roads. The user also may want the polygon edges of the building 315 to be brighter so the silhouettes may be easier to see. The system automatically tints the selection 315, indicating that this building 315 would be good for registration or matching.

Next, the user selects the zoomed region in the photo 300 to which the user would like to register. Also the user may specify that this sub-image of the photo has its edges emphasized, by using an edge detector. Finally, the user may specify that the sub-region of the 3D view 310 and the sub-image of the photo 300 should be merged with an averaging function, over time, that slowly alternates between seeing the 3D view sub-region 310 and the sub-image of the photo 300. The user can stop the function at any time, manipulate the elements 305 315 and start the application again.

In conclusion, the method provides a more intuitive way to merge a 2-d image 300 and a 3-d image. There are a variety of ways of merging the images 300 310 but by providing by the separate image 300 310 and the merged image (along with the numerous helpful tools), improved merged images 320 may be obtained.

Although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A method of combining a first image and a second image comprising:
Displaying the first image adjacent to the second image wherein the second image is a three dimensional image;
Selecting an element in the first image;
Selecting a matching element in the second image;
Allowing a selection to view a merged view wherein the merged view comprises the first image displayed over the second image;
If the merged view is not acceptable, repeating the method;
If the merged view is acceptable; merging the first view onto the second view;
Storing the merged view as a merged image.

2. The method of claim 2, further comprising selecting to highlight elements of the first or second image and lowering the resolution of other elements of the first or second image.

3. The method of claim 1, further comprising merging the first image and second image automatically when sufficient confidence in the merged view exists.

4. The method of claim 1, further comprising displaying wireframes of elements wherein the wireframes comprise outlines of the elements.

5. The method of claim 1, wherein the elements comprise one selected from a group comprising a road, regions, sub-regions, visible object, visible faces; streets, rivers, and bodies of water.

6. The method of claim 1, wherein the first image is opaque and the second image can be seen through the first image.

7. The method of claim 1, wherein the first image is first color and the second image is a second color and the first and second images blend into a third color if they are placed over each other.

8. The method of claim 1, further comprising after having lined up a portion of the first image with a portion the second image, selecting to have an application complete a merger of the first image and second image.

9. The method of claim 1, further comprising allowing an opaque-ness of the second image to be varied.

10. The method of claim 1, further comprising automatically varying opaqueness of the second image when the first image is overlaid the second image.

11. The method of claim 1, further comprising highlighting edges of the objects in the first and second image.

12. The method of claim 11, further comprising registering the edges of the objects in the first image with the edges in the second image.

13. The method of claim 1, further comprising coloring areas in the matched image with a high degree of mismatch a first color and coloring areas with a high degree of match a second color.

14. The method of claim 1, further comprising displaying the first image and the second image at a lower resolution and selecting a portion of the first image to display over the second image.

15. The method of claim 1, further comprising using algorithms to assist in creating the merged image wherein the algorithm is selected from a group comprising:
an algorithm that averages the first image and the second image,
an algorithm that creates the merged image to have a maximum of matching pixels between the first image and the second image and
an algorithm that creates the merged image to have a minimum of non-matching pixels between the first image and the second image.

16. The method of claim 1, wherein the merged view and separate view are displayed on a single display at a same time.

17. A computer storage medium comprising computer executable instructions for combining a first image and a second image, the instructions comprising instructions for:
Displaying the first image adjacent to the second image wherein the second image is a three dimensional image;
Rotating the geometry of elements in the first image and second image toward the face of the first image or the second image;
Selecting an element in the first image;
Selecting a matching element in the second image;
Searching the first image and second image for element matches and if element matches are found, indicating the element matches;
Allowing a selection to view a merged view wherein the merged view comprises the first image displayed over the second image wherein the first image is opaque and the second image can be seen through the first image;
If the quality of the element matches is above a threshold, moving from the split view to the merged view;
If the merged view is not acceptable, repeating the method;
If the merged view is acceptable; merging the first view onto the second view; and
Storing the merged view as a merged image.

18. The computer storage medium of claim 17, further comprising computer executable code for automatically varying opaqueness of the second image when the first image is overlaid the second image.

19. The computer storage medium of claim 17, further comprising computer executable code for coloring areas in the matched image with a high degree of mismatch a first color and coloring areas with a high degree of match a second color.

20. The computer storage medium of claim 17, further comprising computer executable code for using algorithms to assist in creating the merged image wherein the algorithm is selected from a group comprising:
an algorithm that averages the first image and the second image,
an algorithm that creates the merged image to have a maximum of matching pixels between the first image and the second image and
an algorithm that creates the merged image to have a minimum of non-matching pixels between the first image and the second image.
